(19) United States
(12) Patent Application Publication
(10) Pub. No.: US 2008/0294498 A1
(43) Pub. Date: Nov. 27, 2008

(54) METHODS AND APPARATUS TO IMPROVE MARKET LAUNCH PERFORMANCE

(76) Inventors: Christopher Adrien, Cincinnati, OH (US); Joseph Stagaman, Cincinnati, OH (US); Joseph Willke, Cincinnati, OH (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/048,782

(22) Filed: Mar. 14, 2008

Related U.S. Application Data
(60) Provisional application No. 60/931,633, filed on May 24, 2007.

(51) Int. Cl. G06Q 10/00

(52) U.S. Cl. 705/10; 705/7

(57) ABSTRACT

Methods and apparatus to improve market launch performance are disclosed. An example method includes receiving a pre-launch market concept and assessing the concept with a hierarchical framework. Assessing the hierarchical framework further includes identifying a framework dimension, identifying a framework construct associated with the framework dimension, and identifying at least one evaluative factor associated with the framework construct.

### CROSS REFERENCE TO RELATED APPLICATIONS

This application claims the benefit of U.S. Provisional Patent Application Ser. No. 60/931,633, filed May 24, 2007, which is hereby incorporated herein by reference in its entirety.

### FIELD OF THE DISCLOSURE

This disclosure relates generally to market research, and, more particularly, to methods and apparatus to improve market launch performance.

### BACKGROUND

Products and services introduced into a consumer market experience a critical window of opportunity that may dictate whether the product and/or service will succeed. Many factors may contribute to success or failure of the product and/or service, such as packaging, communication of features, and/or novelty in the market. Product manufacturers and/or others chartered with a responsibility of introducing the product and/or service into the marketplace (hereinafter “product marketers”) may employ various techniques to determine whether the product itself, and/or the manner in which the product is marketed, is appropriate for maximum success.

For example, prior to releasing the product and/or service to the market, product/service marketers may employ qualitative research methods, such as, for example, focus groups to evaluate the product and/or service to elicit consumer attitudes, reactions, expectations, etc. Typically, the focus group operates in an informal setting with other group members present, which may allow the product marketers to observe answers to questions, facial expressions, and/or responses (verbal, non-verbal) based on other participants' questions and/or comments. Various sample designs of the product, product packaging, and/or product advertisements may be presented to focus groups to gauge consumer acceptance and/or preferences. Additionally, product marketers may employ quantitative research methods such as, for example, opinion polls to acquire a representation of a sample population, results of which may later be extrapolated to make conclusions about a general population (e.g., one or more demographic groups).

The information received from consumers is a result of questions presented to such consumers. In some instances, product marketers will present consumers with standardized questions in view of a new product and/or service to elicit generalized responses. Based on the generalized responses, the product marketers may pursue various avenues of additional questions to gain insight on a particular facet of the new product and/or service under consumer evaluation. In other instances, product marketers will present such standardized questions to consumers without regard to marketing objectives of the product manufacturer/designer and/or service provider.

### BRIEF DESCRIPTION OF THE DRAWINGS

FIG. 1 is a block diagram of an example system to improve marketable item performance in a competitive market.

FIG. 2 is an example concept stimulus to be assessed and/or evaluated by the example system of FIG. 1.

FIG. 3A is an example framework to guide the concept assessor and/or the concept evaluator of FIG. 1.

FIG. 3B is the example framework of FIG. 3A shown with example evaluative factors.

FIG. 4 is an example user input interface for the system of FIG. 1.

FIG. 5 is an example output of the system of FIG. 1.

FIG. 6 is a flowchart representing example machine readable instructions that may be executed to implement the example concept assessor of FIG. 1.

FIG. 7 is a block diagram of the example concept evaluator of the system of FIG. 1.

FIG. 8 is a flowchart representing example machine readable instructions that may be executed to implement the example concept evaluator of FIG. 1.

FIG. 9 is a block diagram of an example processor system that may be used to execute the example machine readable instructions of FIGS. 6 and/or 8 to implement the example systems, apparatus, and/or methods described herein.

### DETAILED DESCRIPTION

Product marketers typically follow at least one of three recommendations (as provided by their marketing research consultants) after reviewing a product and/or service, and/or one or more marketing materials associated with the product and/or service for the market. For example, in circumstances in which consumer evaluation is favorable, the product marketers may agree that the product and/or service be launched for immediate market availability. Such favorable or unfavorable consumer evaluation of the product and/or service may be influenced by the manner in which the product and/or service is marketed rather than perceived or actual faults and/or benefits of the product and/or service. On the other hand, when some facet(s) of the product and/or service illustrate favorable responses to consumer evaluation (while other facet(s) exhibit one or more problems or opportunities), the product marketers may rework and retest the product and/or service with consumers, and/or rework and retest any promotional and/or marketing materials (e.g., advertisements, packaging, etc.) associated with the product and/or service. By retesting an example product and/or service after rework (e.g., alternate advertisements, alternate product packaging, etc.), product marketers may better confirm an expected degree of success in the market. Finally, if most or all facets of the product and/or service (hereinafter collectively and/or individually referred to as “commercial offering”) illustrate poor consumer reaction(s) and/or acceptance, the product marketers may abandon the product and/or service launch plans.

While recommendations on whether to launch, rework and retest, and/or abandon the commercial offering allow the product marketer to proceed with a course of action, making that recommendation may not be performed in a manner that specifically reflects either commercial offering opportunities or commercial offering problem-areas. Some commercial offering marketers employ a battery of questions that tend to apply to a broad population. While such questions are simple and relatively easy to employ, they may lack value by stating the obvious or missing an objective of the manufacturer/designer of the commercial offering. For example, a commercial offering marketer may employ a generic battery of questions during a commercial offering survey for discount detergent, which may elicit consumer responses that indicate low cost is of primary importance. However, such responses have little value when the commercial offering manufacturer is attempting to differentiate their commercial offering within a field of other discount detergents of relatively the same price. While traditional methods typically focus primarily on volumetric questions (e.g., sales volume forecasting), the methods and apparatus described herein include a standardized assessment that spans the entire consumer adoption process for new commercial offerings. Additionally, the methods and apparatus described herein include a formal structure and toolset(s) to expose what factors contribute to success/failure, why such factors contribute to success/failure, and/or how such factors contribute to the success/failure of commercial offerings. As a result, the systems and methods described herein facilitate better research during the consumer adoption process.

Unlike a standard battery of questions to be used with a consumer evaluation, the methods and apparatus described herein provide a framework to evaluate and recommend changes to new commercial offerings and/or the manner of marketing such commercial offerings to improve marketplace acceptance. The framework includes key dimensions that reflect success for commercial offerings in the market, consumer acceptance, and/or consumer preferences. Each dimension of the framework includes two or more key constructs and the dimension and corresponding construct(s) are assessed and/or evaluated with one or more techniques (e.g., surveys, questionnaires, focus groups, polls, etc.). Each key construct has one or more evaluative factors that characterize the construct. Each evaluative factor may be employed as a question designed to elicit a consumer answer with enhanced focus. Additionally, the evaluative factors may be employed by an analyst to focus product strengths and/or weaknesses of a new commercial offering concept. As discussed in further detail below, a commercial offering concept represents the manner in which potential consumers become aware of the commercial offering. Such concepts may be employed as newspaper/magazine advertisements, television commercials, and/or the manner in which the commercial offering is placed on a store shelf (e.g., a particular shape, color, price-point, etc.).

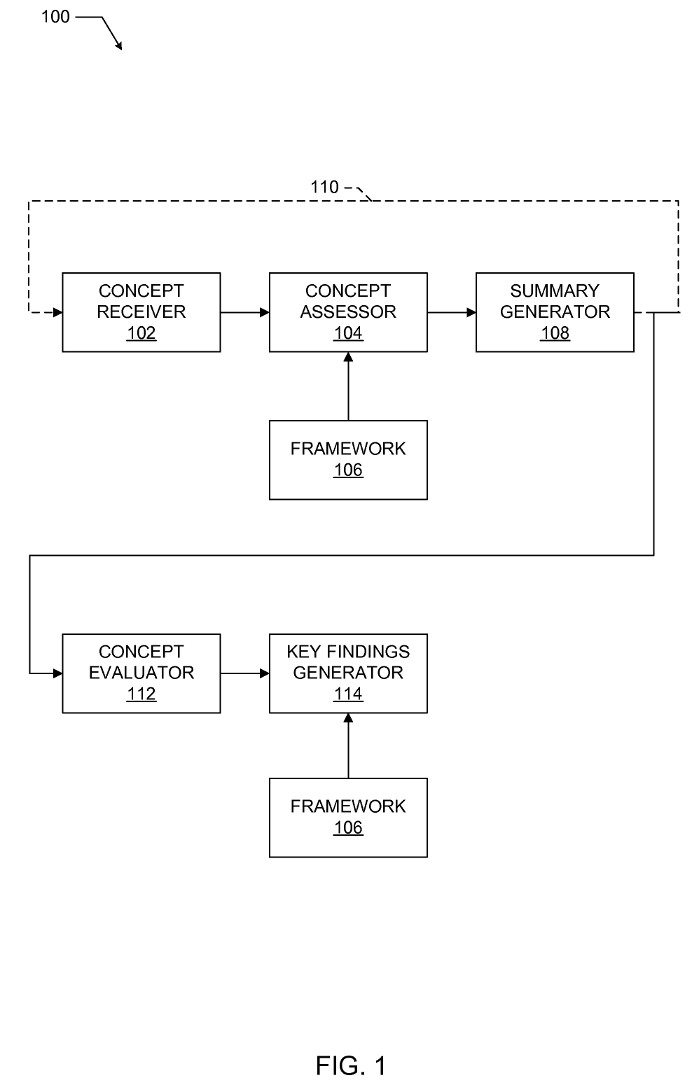

An example system 100 to improve market launch performance in the marketplace is shown in FIG. 1. In the illustrated example of FIG. 1, the system 100 includes a concept receiver 102 to receive concept information from a manufacturer, designer, and/or provider of a commercial offering. Additionally or alternatively, a research analyst may receive the concept information and employ the concept receiver 102 to enter concept information to be assessed by a concept assessor 104. As described in further detail below, the example concept assessor 104 of FIG. 1 is guided and supported by a framework 106 to attempt to identify opportunities to improve a particular concept. The concept assessor 104 facilitates a method to enable the research analyst to consider and assess a commercial offering concept in view of the framework 106 without immediately employing one or more costly surveys, questionnaires, focus groups, and/or consumer polls. As discussed in further detail below, the concept assessor 104 provides the research analyst with a user interface to assess a concept in view of one or more dimensions, constructs, and/or evaluative factors. Additionally, the concept assessor 104 cooperates with a summary generator 108 to generate summary output. Output from the example summary generator 108 of FIG. 1 may allow the analyst an opportunity to determine, based on the applied framework 106, which (if any) facet(s) of the concept are particularly promising and which (if any) facet(s) of the concept are candidate(s) for improvement or elimination.

The manufacturer, designer, and/or provider of the example commercial offering may review the output from the example summary generator 108 of FIG. 1 and decide to abandon the concept, rework the concept and reassess (dotted line 110 in FIG. 1), or evaluate the concept in view of consumer testing with a concept evaluator 112. Unlike the example concept assessor 104 of FIG. 1, the example concept evaluator 112 of FIG. 1 is not limited only to assessment by a research analyst, but takes into consideration consumer feedback based on focused questions that are constrained by the framework 106 and/or based on framework evaluative factors, as discussed in further detail below. In the example of FIG. 1, output from the example concept evaluator 112 in FIG. 1 is used by a key findings generator 114 to provide summary output of the assessed and/or evaluated concept, and allows the manufacturer, designer, and/or provider of the example commercial offering to make decisions on the future handling of the concept (e.g., to launch the concept into the market, to rework and retest the concept, to abandon the concept, etc.).

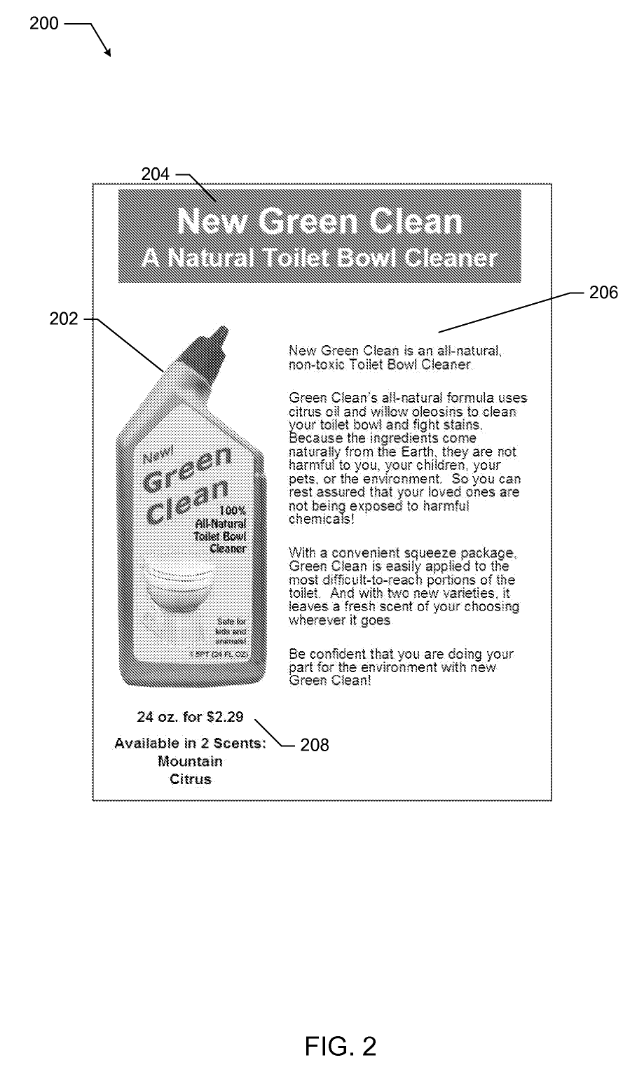

FIG. 2 illustrates an example concept 200 that may be provided by a manufacturer, designer, and/or provider of a commercial offering. The example concept 200 includes one or more stimuli to convey information about the commercial offering, such as a picture stimulus, text stimuli, and/or a stimulus associated with a shape and/or color. In the illustrated example of FIG. 2, the concept 200 includes an image of a product 202 (e.g., toilet bowl cleaner), title splash information 204, a product description 206, and product price-point information 208, all of which represent example stimulus associated with the concept of the commercial offering. The example concept receiver 102 of FIG. 1 may facilitate input of concept 200 stimulus information by way of a data entry kiosk, a graphical user interface (GUI), an application programming interface (API), and/or a personal computer (PC) adapted to allow data entry by a research analyst. For example, the research analyst may receive the concept 200 stimulus from the product designer in the form of an example flyer, a draft advertisement, and/or in electronic media format (e.g., portable document format (PDF), tagged image file format (TIFF), a joint photographic experts group (JPEG) format, a moving picture experts group (MPEG) video, etc.). Without limitation, the concept 200 stimulus may include rough and/or finished commercials (e.g., video tapes/files, films, digital video, etc.) that are live and/or animated. Assessment of the example concept 200 is preceded by entry of one or more facets of the concept 200 stimulus into the concept assessor 104.

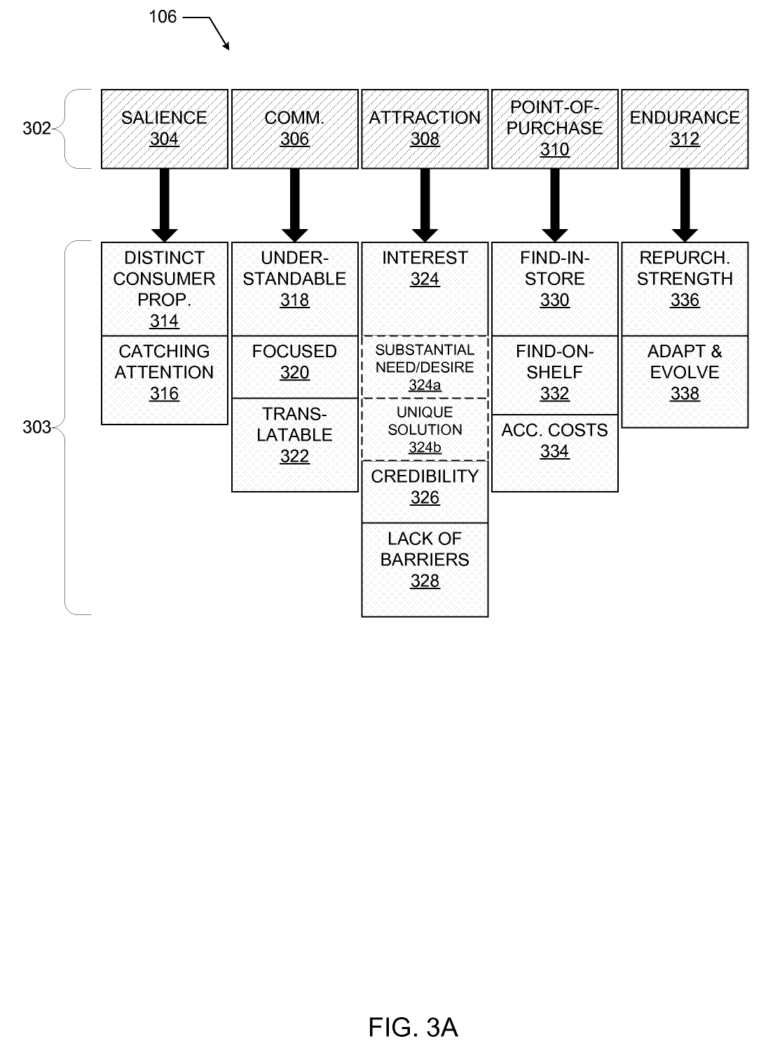

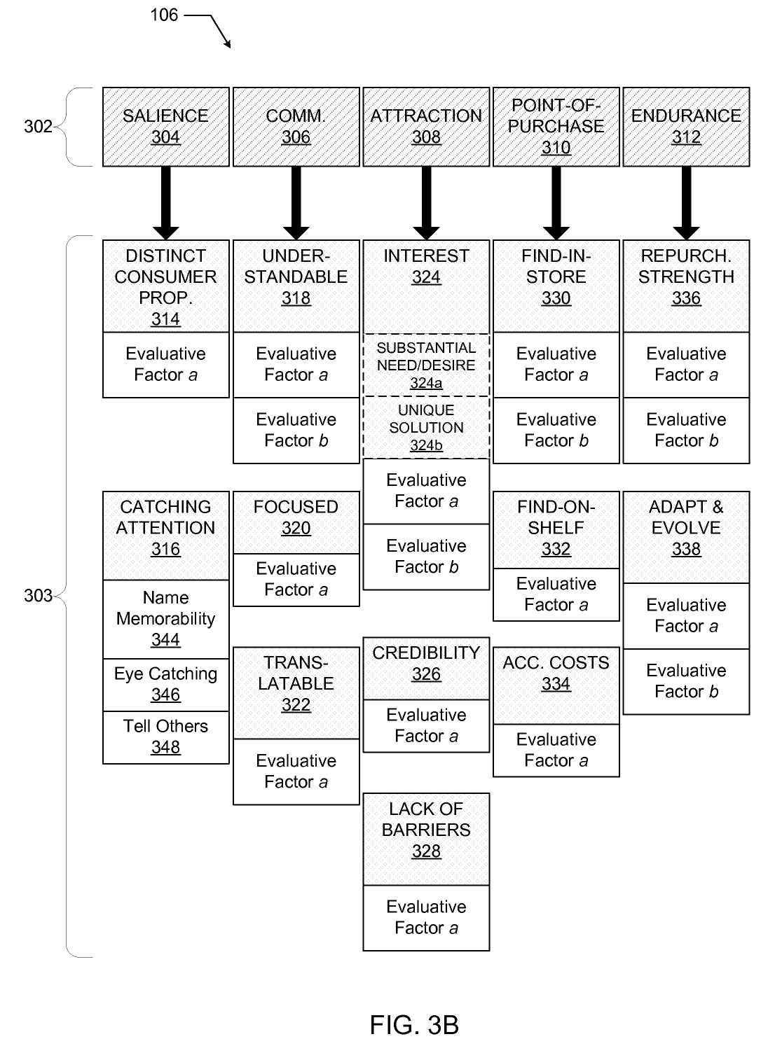

FIG. 3 illustrates an example framework 106 by which the example concept assessor 104 of FIG. 1 makes assessments related to the concept of interest (e.g., the concept 200 from one or more stimuli). The example framework 106 of FIG. 3 includes dimensions 302 identified as contributing to marketplace success of new commercial offerings. The illustrated example dimensions 302 of FIG. 3 include salience 304, communication 306, attraction 308, point-of-purchase 310, and endurance 312 (other dimensions may be used in place of or in addition to the example dimensions 302 shown in FIG. 3). Additionally, the example framework 106 includes one or more constructs 303 within each dimension 302. Together, the dimensions 302 and constructs 303 describe a comprehensive hierarchical model of the consumer adoption process for new commercial offerings. The construct(s) 303 further define their corresponding dimension 302 by, in part, breaking the model down into discrete and/or actionable pieces. For example, the salience dimension 304 includes a construct of “distinct consumer proposition” 314 and a construct of “catching attention” 316. The communication dimension 306 includes a construct of “understandable” 318, a construct of “focused” 320, and a construct of “translatable” 322. The attraction dimension 308 includes a construct of “interest” 324, a construct of “credibility” 326, and a construct of “lack of barriers” 328. The point-of-purchase dimension 310 includes a construct of “find in store” 330, a construct of “find on shelf” 332, and a construct of “acceptable costs” 334. The endurance dimension 312 includes a concept of “repurchase strength” 336, and a construct of “adapt and evolve” 338.

As discussed in further detail below, any or all of the constructs 303 of FIG. 3A may be further defined by one or more evaluative factors (e.g., one or more focused questions/factors or sets of questions) designed to elicit characteristics of the particular construct, as shown in FIG. 3B. Such evaluative factors may also be designed to elicit tactical elements when interviewing consumers of how the construct 303 is expressed. Empirical evaluative factors may be used by analysts when evaluating without consumers' input.

The example salience dimension 304 of FIG. 3A exposes aspects of the concept, such as the concept 200 of FIG. 2, that illustrate whether the concept stands out from what is currently available in the market. In other words, the salience dimension 304 addresses whether the new concept stands out from the competition. Typically, commercial offerings that experience success in the market by virtue of its corresponding concept standing out from the competition in substantial and attention-getting ways. Instead of illustrating whether the concept stands-out in a positive or negative manner, the example salience 304 dimension of FIG. 3A exposes what facets of the concept stand-out, and by how much. In particular, the constructs 303 of “distinct consumer proposition” 314 and “catching attention” 316 facilitate a structure by which the salience dimension 304 may be expressed and understood in view of the example concept. For example, the construct of “distinct consumer proposition” 314 elicits an understanding of whether the concept provides a consumer with reason to believe they should change their current behavior. Typically, concepts associated with successful commercial offerings that enter the market allow the consumer to perceive some new and/or substantial facet of the commercial offering, which results in a change in current behavior (e.g., purchasing an alternative toilet bowl cleaner). To further express a given construct 303, an evaluative factor (e.g., “Evaluative Factor a” in FIG. 3B) may include one or more questions to further describe and/or explain the corresponding higher-level construct(s). Accordingly, any questions employed by an analyst using the example concept assessor 104 of FIG. 1 are tailored for a specific objective based on the corresponding construct(s) 303 and/or dimension(s) 302 in a structured, standardized, and/or repeatable manner.

In the example of FIG. 3A, the salience dimension 304 includes the “catching attention” construct 316 to elicit an understanding of whether the concept grabs the consumer's attention. Typically, products that leverage unique names and/or packaging may more successfully break into a crowded market. As shown in the example of FIG. 3B, evaluative factors to further describe such constructs include “name memorability” 344, “eye catching” 346, and “tell others” 348. For example, an analyst using the example concept assessor 104 of FIG. 1 may utilize and/or design questions that are constrained by the example evaluative factors to obtain an understanding of how well the concept catches attention. Additionally, such evaluative factors may be designed and/or otherwise used to remain neutral to judgment. To illustrate, a licorice pizza would likely generate an eye catching effect in advertising, and also result in the likelihood of consumers telling others, thereby scoring higher on the “catching attention” 316 construct relative to, for example, a cheese pizza.

The example communication dimension 306 of FIGS. 3A and 3B addresses aspects of the concept that convey a consumer proposition. As shown by the constructs of “understandable” 318, “focused” 320, and “translatable” 322, the communication dimension 306 seeks to ascertain whether the concept at issue communicates its message (e.g., via an advertisement, product packaging, etc.) in an understandable, focused, and/or translatable manner. Generally speaking, the translatable construct 322 refers to a notion of the ability to allow others to comprehend a core idea related to a commercial offering. A translatable concept allows such a core idea to be easily conveyed to others, such as by word of mouth and/or an advertisement exposed to potential consumers. As discussed in further detail below, the research analyst provides input related to these constructs 303 in response to evaluative factors designed to elicit answers in view of a concept being assessed. Without limitation, the example dimension(s) 302, construct(s) 303, and/or evaluative factor(s) may be employed to structure one or more analyses of a commercial offering in a focused, standardized, and/or repeatable manner in view of competing products, competing services, and/or consumer feedback.

The example attraction dimension 308 of FIGS. 3A and 3B address aspects of the concept that convey how strongly the consumer is pulled-in to the commercial offering in question based on the communicated commercial offering message and the consumer's needs, desires, and/or perception that the commercial offering will satisfy a void. The “interest” construct 324 of the example attraction dimension 308 is designed to determine whether consumers would be interested in the features, and/or benefits of the commercial offering at issue. This construct 303 includes two example sub-constructs: Substantial Need/Desire 324a and Unique Solution 324b. Interest may be determined first by assessing whether this type of feature(s), and/or benefit(s) meet a substantial need and/or desire, and, if so, to the extent to which that need and/or desire is met.

The interest construct 324 of the example attraction dimension 308 of FIGS. 3A and 3B may further be understood by focusing on a second sub-construct of “unique solution” 324b. The unique solution sub-construct 324b is used to measure the uniqueness of the solution the commercial offering in question provides. The example construct of Interest 324 of FIGS. 3A and 3B includes information from both sub-constructs 324a and 324b, but may instead be a function of one or the other. If a commercial offering meets a need met by a competing and/or existing commercial offering, but in a unique and/or improved manner, then the commercial offering may experience market success. Accordingly, the research analyst may employ and/or design evaluative factors (e.g., “evaluative factor a,” “evaluative factor b,” etc.) directed to the construct(s) 303 of the commercial offering when assessing the example concept 200. Such questions may probe, for example, whether the commercial offering(s) is/are likable, attractive, trivial, and/or substantial. In the example of FIGS. 3A and 3B, a “credibility” construct 326 is used to ascertain a sense of the credibility aspects of the concept in question, and a construct of “lack of barriers” 328 facilitates an understanding of the relative feasibility to bring the commercial offering, features, and/or benefits to the market. As described above, each of the example constructs 303 may include one or more evaluative factors.

The example point-of-purchase dimension 310 of FIGS. 3A and 3B seek to expose one or more aspects of the concept that convey whether the commercial offering can convert consumer attraction to a sale at the point-of-purchase. The point-of-purchase dimension 310 may clarify constructs 303 that focus on whether the product may be found in expected stores (i.e., “find in store” 330), whether the commercial offering may be found on expected shelves and/or aisles of the store (i.e., “find on shelf” 332), and/or whether the commercial offering is sold for an acceptable cost once located (i.e., “acceptable costs” 334). As shown in FIG. 3B, evaluative factors to help illustrate whether the commercial offering may be found in an expected store. Similarly, the “find on shelf” construct 332 may include one or more evaluative factors to help determine whether the commercial offering has the potential to stand-out among adjacent products on the shelf of a retail store and/or outlet. Such potential to stand-out may be influenced by where the commercial offering is placed (e.g., high or low on shelf), product packaging design, shape, color, and/or trademark. In addition, the “acceptable costs” construct 334 illustrates whether consumers would forego a purchase of the commercial offering due to price. One or more evaluative factors may, for example, seek to provide insight regarding how the consumer will evaluate a purchase decision based on price after having an opportunity to view the commercial offering in the store and/or on the shelf. For example, a higher than expected price may not prevent all consumers from purchasing the commercial offering if, for example, a perceived benefit, value, nutrition, and/or quality is deemed sufficiently high.

The example endurance dimension 312 of FIGS. 3A and 3B attempt to expose aspects of the concept that convey a likelihood that the commercial offering will endure over time. In particular, successful commercial offerings are generally seen to achieve lasting consumer adoption through strong commercial offering delivery and continual adaptation and evolution. The “repurchase strength” construct 336 attempts to identify whether the commercial offering meets and/or exceeds consumer expectations and/or perceptions of value. In particular, one or more evaluative factor(s) may identify whether the commercial offering performs, and/or is perceived to perform better than available competitive commercial offerings. Additionally, aspects of repurchase strength may be determined by one or more evaluative factors to ascertain whether the commercial offering performance met and/or exceeded what the consumer expected.

In a dynamic and highly competitive market, competitors are generally expected to respond to newly launched commercial offerings with new and/or improved commercial offerings of their own. In the example of FIGS. 3A and 3B, the construct of “adapt and evolve” 338 of the endurance dimension 312 attempts to determine whether the commercial offering is flexible, protectable (e.g., patentable), and/or capable of future adaptation. One or more evaluative factors may, for example, determine whether the commercial offering requires extensive government and/or other agency approval/testing before iterative product designs are launched. Similarly, one or more evaluative factors may determine whether the product has been, or is capable of being protected by, for example, a patent, a trademark, copyright, and/or trade dress protection.

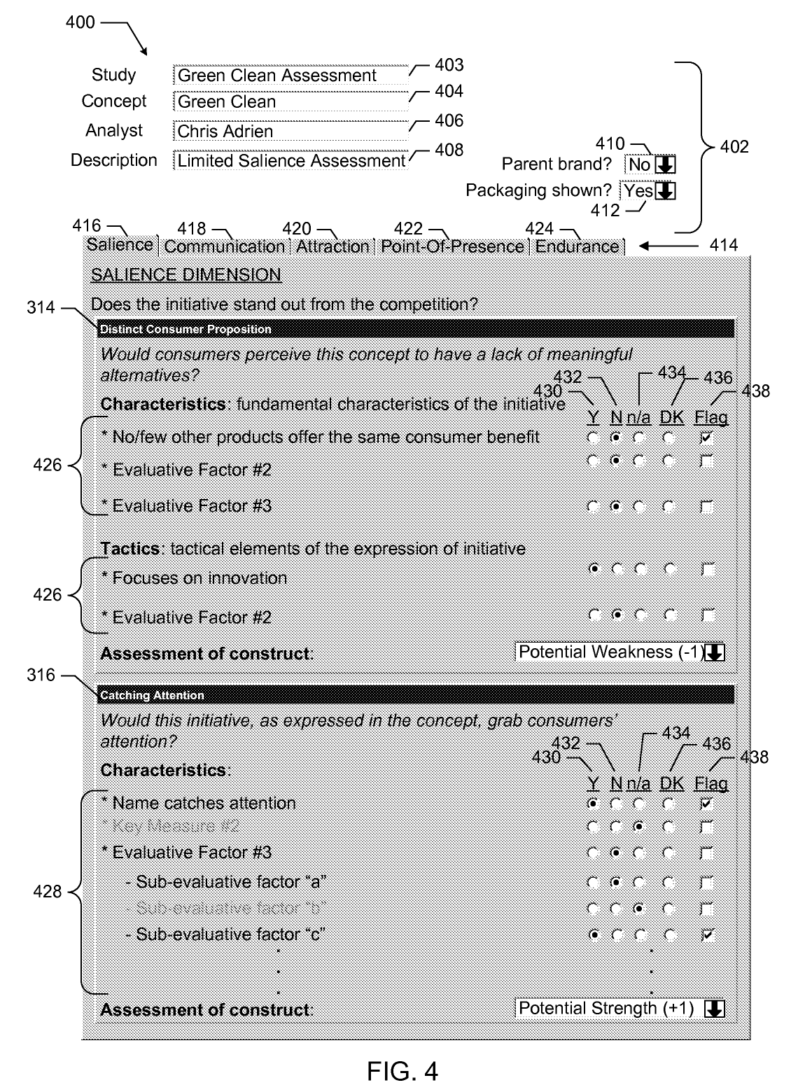

FIG. 4 illustrates an example GUI 400 that may be used by the research analyst to facilitate data entry into the concept assessor 104. The GUI 400 may be implemented via, without limitation, an API, a kiosk, and/or a web-page accessible via a modem, an intranet, and/or the Internet. In the illustrated example of FIG. 4, the GUI 400 includes an editable header section 402 to allow the analyst to identify the product concept, such as the example concept 200 of FIG. 2, and/or one or more stimuli associated therewith. The header section 402 of the illustrated example includes a study name 403, a concept name 404, an analyst name 406, a product description 408, a product brand indicator 410 to identify whether or not the example concept 200 is a line extension (e.g., whether the commercial offering is derived from a parent brand) and a packaging indicator 412 to identify whether or not the example concept 200 includes one or more representations of final (or near final) commercial offering packaging. In the event that certain factors are not relevant to a particular concept 200 under study, then such factors may be marked with a designation of “not-applicable” (N/A).

Dimension tabs 414 allow the analyst to select the salience dimension 304 with a salience tab 416, the communication dimension 306 with a communication tab 418, the attraction dimension 308 with an attraction tab 420, the point-of-presence dimension 310 with a point-of-presence tab 422, and/or the endurance dimension 304 with an endurance tab 424. In the illustrated example of FIG. 4, the salience tab 416 is selected to allow the analyst to review the salience dimension 304, to review the constructs 303 within the salience dimension 312 (i.e., the “distinct consumer proposition” construct 314 and/or the “catching attention” construct 316), and to review one or more evaluative factors for each corresponding construct. In the example of FIG. 4, within the “distinct consumer proposition” construct 314, evaluative factors 426 guide the analyst to consider the example concept stimulus 200 in view of a particular part of the construct. Similarly, FIG. 4 includes evaluative factors 428 associated with the “catching attention” construct 316. Accordingly, the analyst is focused in the assessment process in a hierarchical/structural manner rather than, for example, employing a battery of heuristic questions that may not be relevant to assessing a likelihood of product success in the market. This tends to result in repeatable, useful studies that facilitate comparative analysis between past commercial offerings and the current offering of interest.

As shown in FIG. 4, the lowest level of the assessment hierarchy includes the evaluative factors 426, which are related to an associated construct. Furthermore, while each construct 303 may have multiple evaluative factors, each evaluative factor is preferably related to one construct 303. Finally, while each dimension 302 may have multiple constructs 303, each construct 303 is related to one dimension 302, in which each dimension 302 is at the top of the assessment hierarchy.

Each of the evaluative factors 426, 428 are assessed and may be recorded by the analyst with a radio button. In the illustrated example of FIG. 4, each evaluative factor 426, 428 is associated with a “yes” radio button 430, a “no” radio button 432, a “n/a” (not applicable) radio button 434, a “DK” (don't know) radio button 436, and/or a flag 438. As the analyst reviews each evaluative factor 426, 428 in view of the example concept stimulus 200, a help page may be referenced by the analyst to provide instructions regarding how to answer. For example, the evaluative factor 426 that states “Focuses on innovation” may be associated with analyst instructions to code a “yes” answer if the concept highlights unique aspects of the commercial offering to the consumer. Without limitation, the analyst instructions may include examples of other concepts that illustrate appropriate circumstances in which to code “yes” or “no” for the “focuses on innovation” category. A diet soda concept stimulus, for example, that states “Tastes better than any other diet soda,” would receive a “yes” code because it clearly communicates a difference when compared to competing products. On the other hand, if the diet soda concept stimulus stated “You like soda, but not the empty calories. New <soda name> is your answer,” would receive a “no” code because, while the noted stimulus focuses on a product feature, it does not identify any innovation.

In the event that the analyst believes that additional qualifying information may be appropriate when assessing the example concept stimulus 200, the flag 438 may be selected. Selection of the flag 438 results in presentation of a dialog box to allow the analyst to comment on the evaluative factor 426, 428. Any such comment(s) are made available to the example summary generator 108 and its corresponding output.

While the evaluative factors do not typically change for any particular study, the evaluative factors 426, 428 may be customized and/or edited by the analyst and/or market entity chartered with the responsibility of highlighting potential strengths and/or weaknesses of any particular concept stimulus (e.g., offering). Additional and/or alternate evaluative factors 426, 428 may be stored in a memory and/or database for later recall and use with the concept assessor 104.

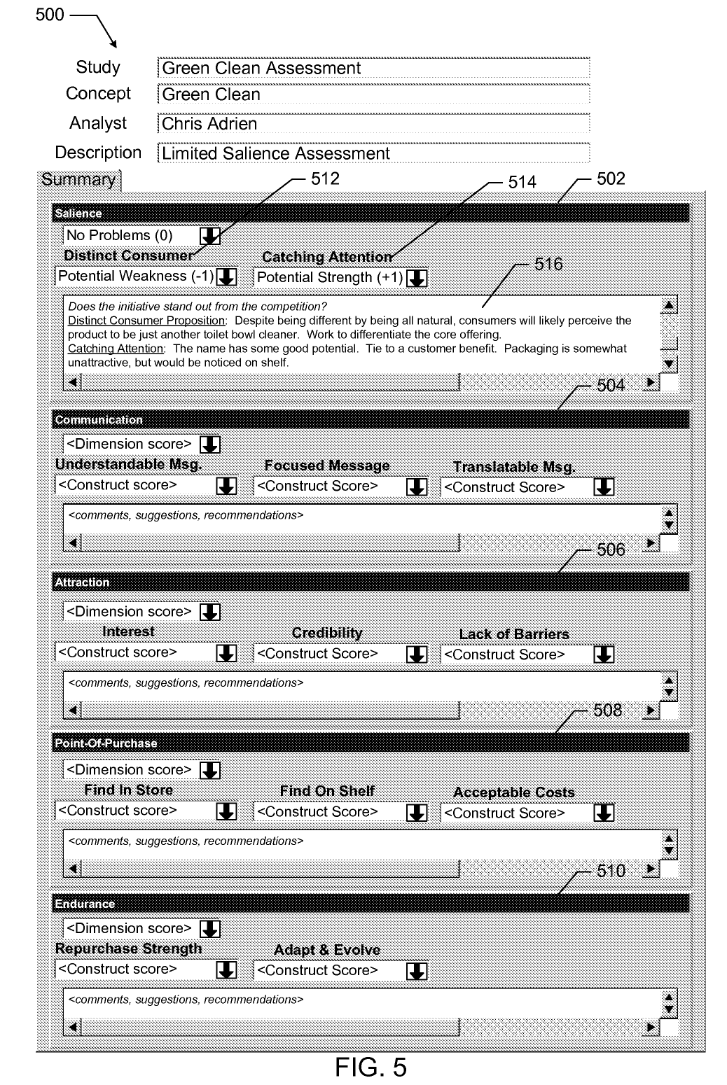

FIG. 5 illustrates an example summary output 500 generated by the example summary generator 108 of FIG. 1. In the illustrated example of FIG. 5, the output 500 includes a salience summary section 502, a communication summary section 504, an attraction summary section 506, a point-of-purchase summary section 508, and an endurance summary section 510. Each summary section also includes a generalized summary evaluation for each assessed construct 303 and an overall summary evaluation for the respective dimension 302. For example, the salience summary section 502 includes a “distinct consumer” score 512 and a “catching attention” score 514, each of which may be coded with a value of −1 to illustrate potential problems, 0 (zero) to illustrate no problems, and/or +1 to illustrate a potential strength for that construct 303. In the event that the analyst selected the flag 438 for any particular evaluative factor, the corresponding entered text is placed within an analyst comment section 516. Such text may become a seed for the analyst to consider and write customized comments in view of the concept stimulus (e.g., advertising materials for the commercial offering in question) and corresponding dimension(s) 302. In view of the analyst assessment activities, the analyst comment section 516, and the construct scoring, the summary output 500 allows the analyst to determine strengths and/or weaknesses of the example concept and/or one or more stimuli of the concept associated with the commercial offering in question and return a recommendation to the product manufacturer, designer, and/or provider of the example commercial offering. The summary output 500 allows the hierarchical assessment by the concept assessor 104 to categorize and segregate focused aspects of the concept stimulus, and the corresponding commercial offering, that may have particular strengths and/or weaknesses. As a result, if the analyst and/or product designer chooses to make changes to the concept stimulus and/or the commercial offering itself, such changes may be based on a logical and structured approach in view of the framework 106, which exposes concept characteristics that tend to reflect successful and/or unsuccessful market performance.

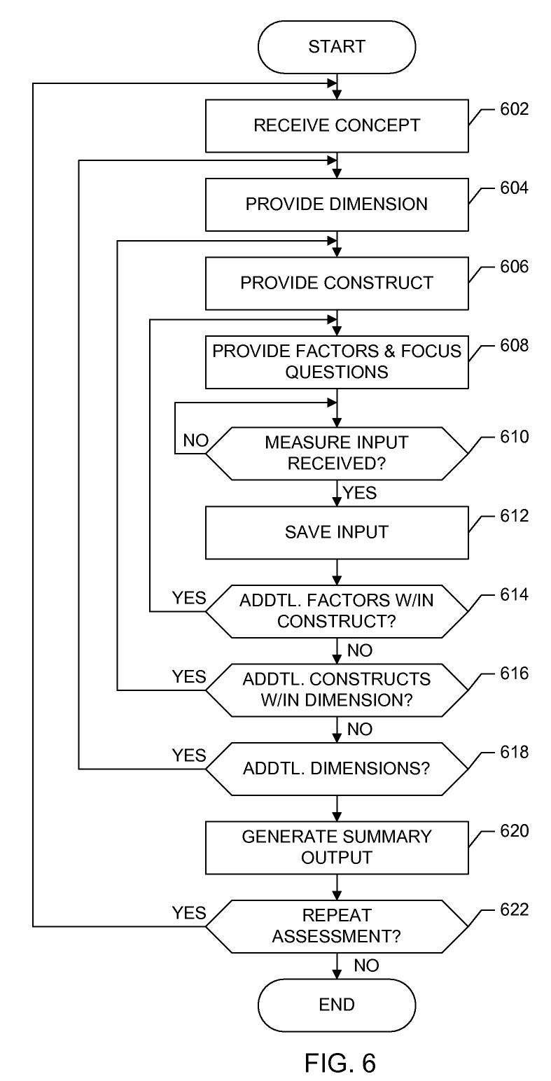

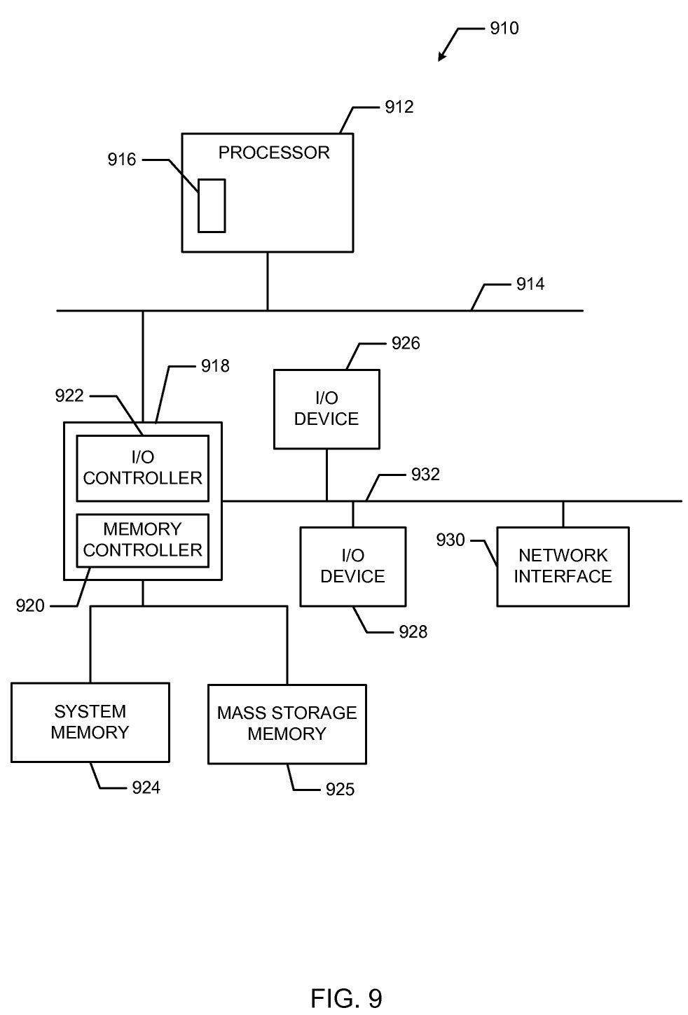

Flowcharts representative of example machine readable instructions for implementing the example concept assessor 104 and the example framework 106 of FIGS. 1, 3, and 4 is shown in FIG. 6. In this example, the machine readable instructions comprise one or more programs for execution by: (a) a processor such as the processor 912 shown in the example processor system 910 discussed below in connection with FIG. 9, (b) a controller, and/or (c) any other suitable processing device. The program may be embodied in software stored on a tangible medium such as, for example, a flash memory, a CD-ROM, a floppy disk, a hard drive, a digital versatile disk (DVD), or a memory associated with the processor 912, but the entire program and/or parts thereof could alternatively be executed by a device other than the processor 912 and/or embodied in firmware or dedicated hardware. For example, any or all of the example concept receiver 102, concept assessor 104, summary generator 108, concept evaluator 112, and/or the key findings generator 114 could be implemented by software, hardware, and/or firmware (e.g., it may be implemented by an application specific integrated circuit (ASIC), a programmable logic device (PLD), a field programmable logic device (FPLD), discrete logic, etc.). Also, some or all of the machine readable instructions represented by the flowchart of FIG. 6 may be implemented manually. Further, although the example program is described with reference to the flowchart illustrated in FIG. 6, many other methods of implementing the example machine readable instructions may alternatively be used. For example, the order of execution of the blocks may be changed, and/or some of the blocks described may be changed, substituted, eliminated, or combined.

The program of FIG. 6 begins at block 602 where the concept receiver 102 receives one or more concept stimuli (e.g., marketing materials) from a product manufacturer, designer, and/or provider of a commercial offering of interest. As described above, the concept receiver 102 may receive the concept and/or one or more stimuli associated with the concept in the form of an example advertisement, flyer, and/or other promotional material in hardcopy and/or electronic format (e.g., a PDF file). The analyst is provided a dimension 302 (block 604) by the concept assessor 104 to apply during assessment of the received concept. Within each dimension 302 are one or more constructs 303, one of which is provided to the analyst (block 606). Within each construct 303 are one or more evaluative factors (block 608), such as the example evaluative factors 426, 428 shown in FIG. 4. The concept assessor 104 determines if the evaluative factor is answered by the analyst (block 610) and saves such answers to a memory (block 612).

If one or more additional evaluative factors for the particular construct remain unanswered (block 614), control returns to block 608, in which any additional evaluative factor(s) related to the construct are provided to the analyst. After all evaluative factors of the selected construct 303 have been answered by the analyst and saved by the example concept assessor 104, the concept assessor 104 determines if the selected dimension 302 includes one or more additional constructs (block 616). Additionally or alternatively, some evaluative factors may be skipped, if not relevant to the particular stimulus and/or stimuli. Control returns to block 606, in which the next construct 303 is identified to the analyst. The example concept assessor 104 will iterate through blocks 606 and 616 until all the evaluative factors of all the constructs 303 of the selected dimension 302 have been assessed or skipped. Similarly, because the example framework 106 of FIG. 3 includes multiple dimensions 302, the concept assessor 104 determines if all dimensions 302 have been assessed (block 618). If not, then control returns to block 604 and the concept assessor 104 provides the next dimension 302 to the analyst for assessment.

When all dimensions 302 have been assessed (which may be identified by a determination that all evaluative factors have been assessed or intentionally skipped (e.g., entry of “DK”), or by selection of an “assessment complete” button) (block 618), then the example summary generator 108 compiles an output (e.g., a report) to be discussed with the product manufacturer, designer, and/or provider of the concept associated with the commercial offering that was assessed (block 620). The concept assessor 104 and the constraints provided by the framework 106 allow the analyst and/or product designer to gain insight on potential strengths and/or potential weaknesses of the concept (i.e., the stimulus and/or stimuli associated with the commercial offering) before additional effort and/or money is spent with a commercial offering launch into the marketplace. In particular, the output from the concept assessor 104 may indicate that a commercial offering launch is premature and/or unlikely to succeed in the current market, thereby counseling against making the launch at the present time or in the present form. However, rather than recommend that the entire concept of the commercial offering be reworked, the hierarchical assessment by the concept assessor 104 allows the analyst and/or product designer to focus rework efforts by specifically identifying one or more facets of the concept that exhibit particular weakness(es). Such focused feedback may result in efficient, timely, and/or money saving efforts to rework, reassess, and/or abandon the concept. If the product designer chooses to rework and repeat the assessment (block 622), control returns to block 602, and the new concept stimulus is assessed.

Testing a new concept with a sample audience (e.g., one or more focus groups, opinion polls, etc.) typically includes substantial amounts of time and money. At least one benefit of the example concept assessor 104 is to focus and prioritize facets of the concept (e.g., particular elements of a concept stimulus (e.g., a picture of the commercial offering)) that may result in the largest post-launch consumer impact. While the example concept assessor 104 does not typically elicit direct consumer input, dimensions 302 and constructs 303 of the framework 106 are applied during a further concept evaluation along with a collection of standard consumer measures, in which actual consumers are presented with one or more facets (e.g., one or more stimuli) of the concept. As described above, the example concept evaluator 112 may be employed to elicit consumer feedback after a concept assessment by the example concept assessor 104. However, the example concept evaluator 112 may be employed independently of the concept assessor 104, and visa versa.

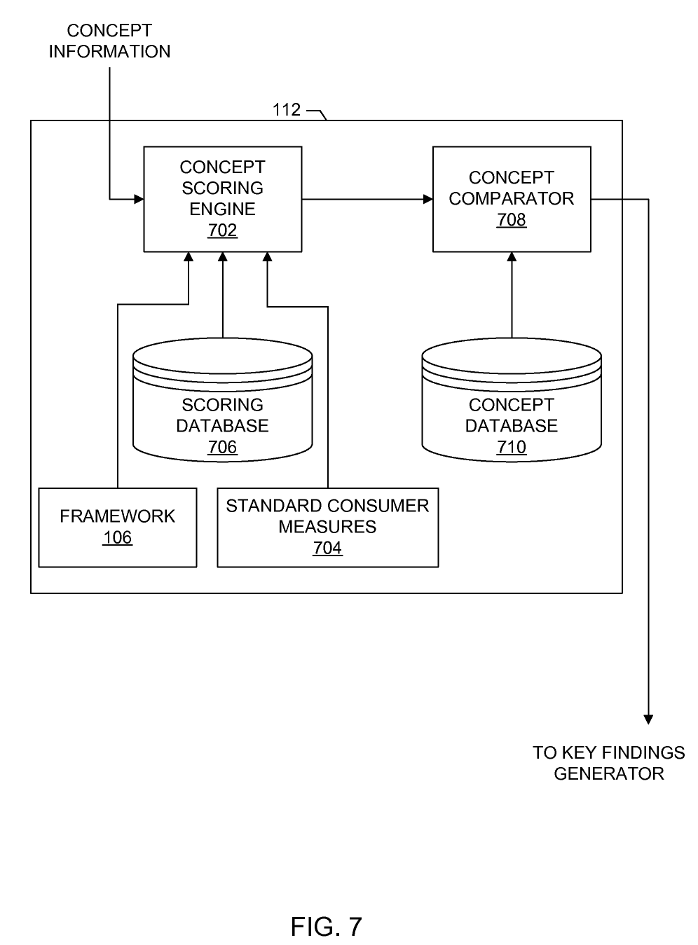

Referring to FIG. 7, an example implementation of the concept evaluator 112 of FIG. 1 is shown in greater detail. The example concept evaluator 112 includes a concept scoring engine 702 communicatively connected to the framework 106, standard consumer measures 704, and a scoring database 706. Additionally, the example concept evaluator 112 includes a concept comparator 708 to receive scoring results from the scoring engine 702 and historic concept information from a concept database 710. As described in further detail below, output from the example concept comparator 708 may illustrate relative strengths and/or weaknesses of the evaluated concept in view of similar commercial offerings that have previously been introduced into the market.

The manufacturer, designer, and/or provider of the example commercial offering(s) may employ market research techniques (e.g., focus groups, opinion polls, surveys, etc.) and provide results from such techniques to the concept scoring engine 702. The research techniques may include polling any number of consumers (e.g., 200-300) and/or may use one or more questionnaires that include, without limitation, the standard consumer measures 704 and/or the example evaluative factors from the framework 106 described above. Generally speaking, the standard consumer measures 704 may include survey questions developed by a marketing entity that are generalized and/or empirically determined to be effective at eliciting certain consumer responses, attitudes, and/or expectations. Such questions of the standard consumer measures 704 are not necessarily associated with the framework 106, but may be more generalized and are directed to identifying and/or learning about one or more characteristics of the concept, such as, but not limited to, consumer category usage, past product experiences, and/or demographics that are typical of, and/or intended to be associated with the concept and/or corresponding commercial offering. Depending on the type of commercial offering and/or identified weaknesses from the concept assessor 104, other diagnostic questions may be tailored accordingly. Each consumer response to a standard consumer measure 704 and/or an evaluative factor is assigned a score by the concept scoring engine 702. In the illustrated example of FIG. 7, the concept scoring engine 702 receives results (generally in the form of a mean, proportion, and/or some other aggregated metric) from the framework 106 related to a particular construct 303. An example standard consumer measure associated with the salience dimension may include, “If new <commercial offering name> was not available, which statement best describes the alternatives that are available for you to buy?” Answers to the example standard consumer measure may be constrained to a discrete number of consumer choices such as, for example, “(a) Many alternatives, (b) Few alternatives, (c) One or two alternatives, or (d) No alternatives.” The example concept scoring engine 702 may access the scoring database 706 to associate scoring values for each discrete answer choice of the standard consumer measure. Persons and/or organizations chartered with market research duties may employ one or more scoring weights depending on theoretically and/or empirically derived observations. As such, the scoring database 706 allows flexibility when evaluating consumer responses to a commercial offering concept based on standard consumer measures and/or evaluative factors including, but not limited to, commercial offering launch geography, target audience demographics, and/or seasonal influences.

Continuing in view of the example discrete choices (a) through (d) above, the scoring database 706 may provide the scoring engine with an answer scoring set. The example answer choice (a) (“Many alternatives”) may be assigned a scoring weight of six, the example answer choice (b) (“Few alternatives”) may be assigned a scoring weight of three, the example answer choice (c) (“One or two alternatives”) may be assigned a scoring weight of 1.5, and the example answer choice (d) (“No alternatives”) may be assigned a scoring weight of zero. Scoring weights may be assigned in any desired manner. For example, a relatively high value weight may represent a favorable score in some instances (e.g., instances seeking to ascertain whether product packaging was eye catching), or the relatively high value weight may represent an unsatisfactory score in other instances (e.g., instances seeking to ascertain how negatively a consumer reacted to the product packaging). As described above, the example question “If new <commercial offering name> was not available, which statement best describes the alternatives that are available for you to buy?” may be associated with the example construct “distinct consumer proposition” 314 of the framework 106 to determine whether a consumer is influenced by alternative commercial offerings. All evaluative factors and/or standard consumer measures associated with the constructs 303 may be assigned a corresponding score by the concept scoring engine 702. Additionally, such scores may be aggregated to derive a construct score. Construct scores may also be aggregated to derive a score for each dimension 302 from which the constructs 303 are associated. One or more equations may be employed to derive a score for each dimension 302 that, for example, calculates particular weighting factors depending on the example stimulus. A dimension score may additionally or alternatively be generated that, for example, multiplies one or more weighting factors to construct scores (e.g., “distinct consumer proposition” 314) based on a particular market subgroup. For example, a sub-market category related to breakfast cereals may assign a relatively higher weighting factor to the construct of “catching attention” (CA) 316, while a sub-market category related to pharmaceutical products may assign a relatively higher weighting factor to the construct of “distinct consumer proposition” (DCP) 314.

A DCP variable may be equal to the value associated with a consumer's answer to a single question. Alternatively, the DCP variable may be equal to an aggregate number of response weight values associated with two or more evaluative factors related to the “distinct consumer proposition” construct 314.

In the illustrated example of FIG. 7, each score derived by the concept scoring engine 702 is provided to the concept comparator 708 to compare the dimension results with other commercial offerings of a similar category. The concept comparator 708 retrieves similar commercial offerings (e.g., 20 or more) and corresponding dimension score values from the concept database 710 and compares the new concept results to results for other commercial offerings in an effort to illustrate relative strengths and/or weaknesses of the new concept. The concept database 710 includes, but is not limited to, concept dimension scores from previously evaluated commercial offerings, countries in which previous commercial offerings were sold, corresponding market success and/or failure metrics, commercial offering category data, commercial offering price, etc. Accordingly, the concept comparator 708 may select only relevant commercial offerings from the concept database 710 to improve evaluation relevance. For example, if the new concept being evaluated is associated with a commercial offering of toothpaste sold only in Canada, then the concept comparator 708 retrieves previous commercial offering information from the concept database 710 related to toothpaste sold in Canada, representing the likely competition the new commercial offering would face in the market at launch. Additionally, the retrieved information may be further filtered by one or more toothpaste selling price points, sizes, and/or target age categories (e.g., children toothpaste commercial offerings, adult toothpaste commercial offerings, toothpaste commercial offerings for dentures, etc.). Each scored and compared dimension 302, construct 303, and/or evaluative factors result may be provided as an output for analysis by the commercial offering manufacturer, designer, and/or provider of the evaluated commercial offering. Such output information may provide the product designer with feedback to facilitate a decision on whether to launch the commercial offering, rework the commercial offering in view of potential weaknesses, and/or abandon the commercial offering launch.

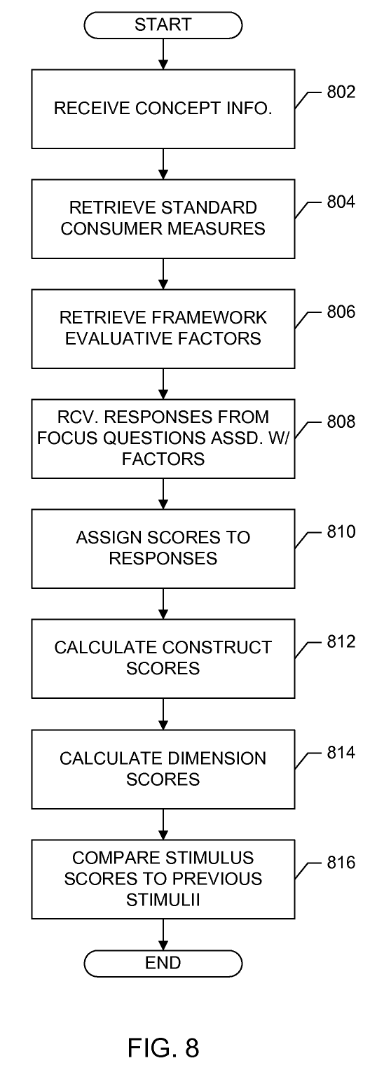

A flowchart representative of example machine readable instructions for implementing the concept evaluator 112 of FIGS. 1 and 7 is shown in FIG. 8. In this example, the machine readable instructions comprise one or more programs for execution by: (a) a processor such as the processor 912 shown in the example processor system 910 discussed below in connection with FIG. 9, (b) a controller, and/or (c) any other suitable processing device. The program may be embodied in software stored on a tangible medium such as, for example, a flash memory, a CD-ROM, a floppy disk, a hard drive, a digital versatile disk (DVD), or a memory associated with the processor 912, but the entire program and/or parts thereof could alternatively be executed by a device other than the processor 912 and/or embodied in firmware or dedicated hardware. For example, any or all of the example concept scoring engine 702, the scoring database 706, the concept comparator 708, and/or the concept database 710 could be implemented by software, hardware, and/or firmware (e.g., it may be implemented by an ASIC, a PLD, a FPLD, discrete logic, etc.) Also, some or all of the machine readable instructions represented by the flowchart of FIG. 8 may be implemented manually. Further, although the example program is described with reference to the flowchart illustrated in FIG. 8, many other methods of implementing the example machine readable instructions may alternatively be used. For example, the order of execution of the blocks may be changed, and/or some of the blocks described may be changed, substituted, eliminated, or combined.

The program of FIG. 8 begins at block 802 where the concept evaluator 112 receives concept information associated with the commercial offering to be evaluated by one or more consumers. Generally speaking, the concept information received by the concept evaluator 112 allows the evaluation to be performed in a focused and efficient manner by utilizing topics associated with dimensions 302 that are likely to clarify potential strengths and/or weaknesses of the commercial offering. In particular, if the example concept assessor 104 was employed before soliciting the services of the concept evaluator 112, then one or more dimensions 302 and/or constructs 303 within those dimensions 302 may have been identified as potential weaknesses of the commercial offering. Accordingly, such information may allow subsequent evaluation by the concept evaluator 112 to employ topics related to those dimensions 302 that may require additional attention and/or rework before the commercial offering is launched into the marketplace.

Standard consumer measures 704 are retrieved by the concept scoring engine 702 (block 804), and may be filtered based on characteristics of the received concept information. Several thousand standard consumer measures may exist as tools for the analyst to gain insight from consumers about a commercial offering, but some of those standard consumer measures may not be relevant for every commercial offering concept to be evaluated. Similarly, framework evaluative factors are retrieved by the concept scoring engine 702 (block 806) and may be filtered based on characteristics of the received concept information. For example, if a prior concept assessment resulted in recommendations that the salience dimension 304 strength was significantly above average while the communication dimension 306 was significantly below average, then the retrieved framework evaluative factors related to the communication dimension 306 may allow more useful and/or relevant feedback from consumers during the evaluation than the salience dimension 304. Thus, the amount of questions employed via framework evaluative factors associated with the salience dimension 304 may be reduced, while a relatively larger percentage of questions employed via framework evaluative factors associated with the communication dimension 306 may be included.

The standard consumer measures and framework evaluative factors are presented to consumers during a market research initiative. Such market research initiatives may take any form including, by way of example, not limitation, focus groups, on-line surveys, questionnaires, and/or polling. Corresponding measures are received by the concept scoring engine 702 (block 808) and assigned a scoring value (block 810). As described above, each consumer may be presented with a discrete number of answer choices, each of which is associated with a corresponding weight. In the illustrated example of FIG. 8, the concept scoring engine 702 retrieves construct formulas from the scoring database 706 to calculate a construct score (block 812). The resulting construct score(s) allow calculation of corresponding scores for the dimension(s) (block 814).

As described above, the concept comparator 708 receives results from the scoring engine and compares the evaluated concept (e.g., a stimulus) with historical information (block 816). In particular, the concept database 710 includes scoring results of other concepts that have been previously evaluated. As such, the concept comparator 708 extracts concept results from the concept database 710 of a similar category/type so that the recently evaluated concept can be compared in a relative manner. Without limitation, the concept comparator 708 may extract other concept results for comparison purposes based on category limitations (e.g., grocery products, pharmaceutical products, cleaning products, services, etc.) and/or demographic limitations (e.g., commercial offerings typically consumed by people of a particular age category).

FIG. 9 is a block diagram of an example processor system 910 that may be used to execute the example machine readable instructions of FIGS. 6 and 8 to implement the example systems, apparatus, and/or methods described herein. As shown in FIG. 9, the processor system 910 includes a processor 912 that is coupled to an interconnection bus 914. The processor 912 includes a register set or register space 916, which is depicted in FIG. 9 as being entirely on-chip, but which could alternatively be located entirely or partially off-chip and directly coupled to the processor 912 via dedicated electrical connections and/or via the interconnection bus 914. The processor 912 may be any suitable processor, processing unit or microprocessor. Although not shown in FIG. 9, the system 910 may be a multi-processor system and, thus, may include one or more additional processors that are identical or similar to the processor 912 and that are communicatively coupled to the interconnection bus 914.

The processor 912 of FIG. 9 is coupled to a chipset 918, which includes a memory controller 920 and an input/output (I/O) controller 922. The chipset provides I/O and memory management functions as well as a plurality of general purpose and/or special purpose registers, timers, etc. that are accessible or used by one or more processors coupled to the chipset 918. The memory controller 920 performs functions that enable the processor 912 (or processors if there are multiple processors) to access a system memory 924 and a mass storage memory 925.

The system memory 924 may include any desired type of volatile and/or non-volatile memory such as, for example, static random access memory (SRAM), dynamic random access memory (DRAM), flash memory, read-only memory (ROM), etc. The mass storage memory 925 may include any desired type of mass storage device including hard disk drives, optical drives, tape storage devices, etc.

The I/O controller 922 performs functions that enable the processor 912 to communicate with peripheral input/output (I/O) devices 926 and 928 and a network interface 930 via an I/O bus 932. The I/O devices 926 and 928 may be any desired type of I/O device such as, for example, a keyboard, a video display or monitor, a mouse, etc. The network interface 930 may be, for example, an Ethernet device, an asynchronous transfer mode (ATM) device, an 802.11 device, a digital subscriber line (DSL) modem, a cable modem, a cellular modem, etc. that enables the processor system 910 to communicate with another processor system.

While the memory controller 920 and the I/O controller 922 are depicted in FIG. 9 as separate blocks within the chipset 918, the functions performed by these blocks may be integrated within a single semiconductor circuit or may be implemented using two or more separate integrated circuits.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to assess market performance comprising:
receiving a pre-launch market concept; and
assessing the concept with a hierarchical framework comprising:
identifying a framework dimension;
identifying a framework construct associated with the framework dimension; and
identifying at least one evaluative factor associated with the framework construct.

2. A method as defined in claim 1, further comprising generating at least one recommendation based on a response to the at least one evaluative factor.

3. A method as defined in claim 2, wherein the at least one recommendation comprises at least one of conduct a consumer study, rework the concept, abandon the concept, or forward the concept to market.

4. A method as defined in claim 3, wherein conducting a consumer study comprises at least one of a consumer survey, a consumer questionnaire, a focus group, or a consumer poll.

5. A method as defined in claim 1, wherein the framework dimension corresponds to characteristics associated with at least one of market success, consumer acceptance, or consumer preference of the concept.

6. A method as defined in claim 1, further comprising assigning a score to the at least one evaluative factor.

7. A method as defined in claim 6, further comprising assigning a score to the framework construct based on the score of the at least one evaluative factors.

8. A method to improve market performance at launch comprising:
receiving a concept associated with a commercial offering;
retrieving standard consumer measure associated with a characteristic of the concept;
retrieving a framework evaluative factor corresponding to the characteristic from a hierarchical framework; and
applying the standard consumer measure and the framework evaluative factor to a research initiative to determine market response to the concept.

9. A method as defined in claim 8, wherein applying the standard consumer measure and the framework evaluative factor further comprises assigning a first score to the framework evaluative factor and a second score to the standard consumer measure based on consumer responses to the concept.

10. A method as defined in claim 9, further comprising calculating at least one of a construct score or a dimension score.

11. A method as defined in claim 10, further comprising comparing the at least one of the construct score or the dimension score to at least one stored score to determine a relative success factor of the received concept.

12. A method as defined in claim 11, further comprising selecting the at least one stored score based on at least one of a category limitation, a geographic limitation, or a demographic limitation.

13. A method as defined in claim 8, wherein receiving the framework evaluative factor comprises:
identifying at least one framework dimension;
identifying at least one framework construct associated with the at least one framework dimension; and
selecting the framework evaluative factor from a plurality of evaluative factors associated with the at least one framework construct.

14. An apparatus to improve market performance at launch comprising:
a concept receiver to convert a concept associated with a commercial offer of a product into a format for evaluation;
a framework to provide a hierarchy of dimensions, constructs, and evaluative factors; and
a concept evaluator to automatically apply the framework to the received concept to generate a relative success factor for the received concept.

15. An apparatus as defined in claim 14, wherein the dimensions correspond to marketplace success factors, and the constructs correspond to consumer adoption factors of the dimensions.

16. An apparatus as defined in claim 15, wherein the evaluative factors are associated with constructs, and the evaluative factors are questions to elicit values associated with their corresponding constructs.

17. An apparatus as defined in claim 14, wherein the concept evaluator further comprises a concept scoring engine to calculate a scoring value for a first one of the evaluative factors.

18. An apparatus as defined in claim 17, further comprising a scoring database to provide at least one framework formula to calculate a construct score of a first one of the constructs, the score based on the scoring value for the first evaluative factor.

19. An apparatus as defined in claim 18, further comprising a concept comparator to compare the construct score with at least one stored score associated with another commercial offering to determine a relative success factor.

20. An article of manufacture storing machine readable instructions which, when executed, cause a machine to:
receive a pre-launch market concept; and
assess the concept with a hierarchical framework comprising:
identifying a framework dimension;
identifying a framework construct associated with the framework dimension; and
identifying at least one evaluative factor associated with the framework construct.

21. An article of manufacture as defined in claim 20, wherein the machine readable instructions further cause the machine to generate at least one recommendation based on a response to the at least one evaluative factor.

22. An article of manufacture as defined in claim 21, wherein the machine readable instructions further cause the machine to recommend at least one of conduct a consumer study, rework the concept, abandon the concept, or forward the concept to market.

23. An article of manufacture as defined in claim 20, wherein the machine readable instructions further cause the machine to assign a score to the at least one evaluative factor.

24. An article of manufacture as defined in claim 23, wherein the machine readable instructions further cause the machine to assign a score to the framework construct based on the score of the at least one evaluative factor.
